(19) United States
(12) Patent Application Publication
(10) Pub. No.: US 2008/0140530 A1
(43) Pub. Date: Jun. 12, 2008

(54) Automated Inventory Interface to Advertisement Campaigns

(75) Inventors: Andrew S. Van Luchene, Santa Fe, NM (US); Joel Mahoney, Santa Fe, NM (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, Santa Fe, NM (US)

(21) Appl. No.: 11/948,043

(22) Filed: Nov. 30, 2007

Related U.S. Application Data
(63) Continuation-in-part of application No. 11/608,150, filed on Dec. 7, 2006.

(51) Int. Cl. G06Q 30/00

(52) U.S. Cl. 705/14; 705/26

(57) ABSTRACT

A system and method to allow advertisers to create targeted advertisements which display the current availability of particular inventory based on the search criteria of a consumer. Such systems and methods also allow the transfer of search terms to the website of the vendor, minimizing the efforts required by the consumer in order to complete a transaction.

### CROSS REFERENCE TO RELATED APPLICATIONS

The present application is a continuation-in-part of U.S. patent application Ser. No. 11/608,150, entitled “Map and Inventory-Based On-Line Purchases,” filed Dec. 7, 2006, which is incorporated by reference in its entirety.

### BACKGROUND

Online searches driven by Web-based search engines have proven to be one of the most prevalent uses of computer networks such as the Internet. Computer users can employ a variety of search tools to search for information as well as goods and services. Once users have identified the content of interest, they can frequently click through to an advertiser's website for related information or to view a particular product or service. However, the availability of a product or service at a given point of time is often unclear until the user arrives at the advertiser's website. This can be time consuming and frustrating, resulting in lost revenue and wasted advertising budgets. It would therefore be advantageous to provide improved methods and apparatus for displaying available inventory earlier in the search process.

### BRIEF DESCRIPTION OF THE DRAWINGS

FIG. 1 is a block diagram depicting a network according to an embodiment of the present disclosure.

FIG. 2 is a block diagram depicting a system 100 according to one embodiment of the present invention.

FIG. 3 illustrates a method of opening an account with an advertising system according to one embodiment of the invention.

FIG. 4 illustrates a method of preparing an advertising campaign according to one method of the invention.

FIG. 5 illustrates a method of processing a search request according to one embodiment of the invention.

### DETAILED DESCRIPTION

Interactive distribution mediums such as the Internet have created new ways for advertisers to reach consumers including keyword advertising, behavioral advertising and contextual advertising. In keyword advertising, a consumer types a keyword or search string into a search engine. Based on the keyword or search string entered, the consumer may be directed to a website containing a list of relevant advertisements. Behavioral advertising works by anonymously monitoring and tracking the content read and sites visited by a user as that user surfs the Internet and then displaying targeted advertising related to that user's behavioral classification. Contextual advertising involves displaying ads on web pages where the advertisements are selected and served by automated systems based on the content displayed.

Online ads may be displayed in any number of formats. For example, as banner advertisements across a web page, in a pop up, in a pull down menu, as part of a widget or other interactive virtual tool, in a side bar, across some or all of a web page, or in any other format designed to attract the attention of an end user.

Whether keyword advertising, behavioral advertising, contextual advertising, or other types of advertising, the goal is to display targeted ads to a particular consumer and to allow the consumer to efficiently acquire the product or service in the ads. After viewing the ads, a certain percentage of searchers will typically select or “click on” an advertisement of interest, and are then redirected to a website providing additional information related to the advertisement. Current systems can be frustrating in that the availability of the particular product or service displayed in the ad or the result of a search may not be known until the consumer has taken several additional steps. This delay of knowledge can lead to aggravation and wasted time on the part of the consumer and wasted advertising budgets and loss of good will on the part of the advertiser.

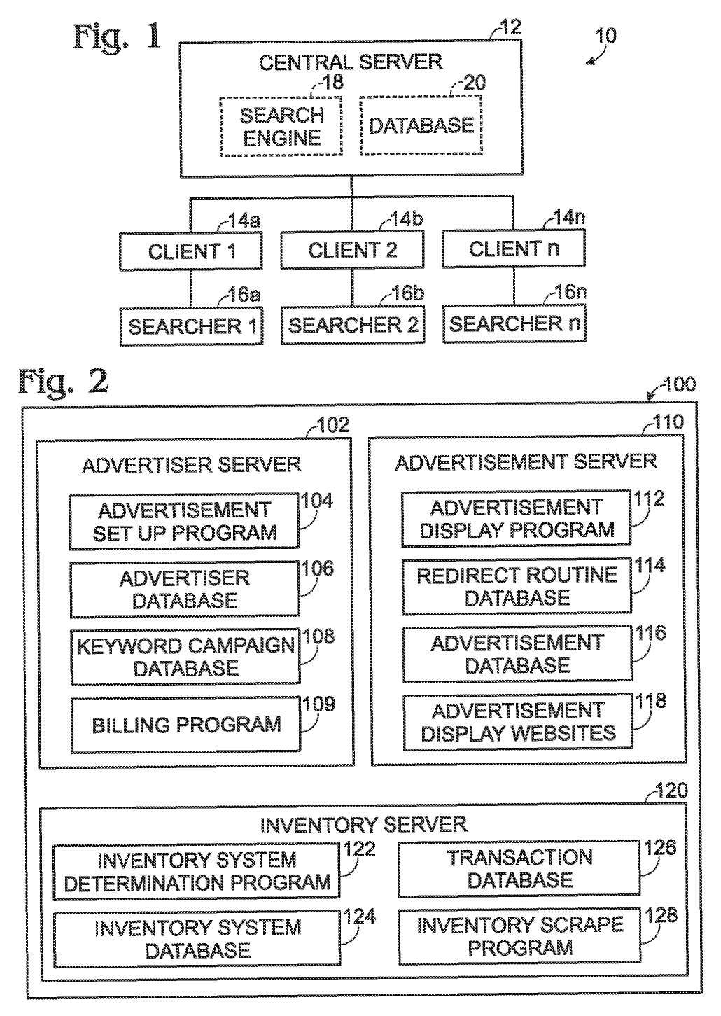

The herein described aspects and drawings illustrate components contained within, or connected with other components that permit improved online advertising. It is to be understood that such depicted designs are merely exemplary and that many other designs may be implemented to achieve the same functionality. Any arrangement of components to achieve the same functionality is effectively associated such that the desired functionality is achieved. FIG. 1 provides an exemplary network which may be used to support a virtual environment.

Turning now to FIG. 1, a system 10 suitable for use according to one embodiment of the present disclosure is depicted. As shown, the system includes a central server 12 which is in electronic communication with one or more client computing devices 14. Each client computing device 14 allows one or more users 16 to access central server 12. System 10 is configured such that a search engine can receive a search request from a user, retrieve search results from one or more databases, and provide the search results to the user. Numerous configurations for the locations of the search engine and databases are possible. According to the depicted embodiment, a search engine 18 and one or more databases 20 are hosted by central server 12. However, it will be readily understood that search engine 18 may, for example, be located on one or more client computing devices 14, on another server in electronic communication with central server 12, or elsewhere, so long as search engine 18 is in electronic communication with and accessible by the client computing device. Moreover, it will be further understood that databases 20 may be located, collectively, or individually, in numerous locations in the system, including without limitation, on central server 12, on a different server, on a client computer device, etc. Moreover, it will be understood that search engine 18 may be capable of accessing a first database in a first location and a second database in a second location, etc. and assembling search results from multiple databases. Regardless of the location of the search engine and databases, the user will typically access the search engine through some type of user interface such as, for example, a web browser.

Central server 12 and client computing device 14 may be, for example, appropriately programmed general purpose or dedicated computers and computing devices. Accordingly, such devices will typically include a processor configured to receive and execute instructions from a computer program. Thus, it will be understood that the various processes and methods described herein may be implemented by an appropriately programmed general or purpose or dedicated computer or computing device.

For the purposes of the present disclosure, a “processor” means one or more microprocessors, central processing units (CPUs), computing devices, microcontrollers, digital signal processors, or like devices or any combination thereof. Typically a processor (e.g., one or more microprocessors, one or more microcontrollers, one or more digital signal processors) will receive instructions (e.g., from a memory or like device), and execute those instructions, thereby performing one or more processes defined by those instructions.

Thus a description of a process is likewise a description of an apparatus for performing the process. The apparatus can include, e.g., a processor and those input devices and output devices that are appropriate to perform the method.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

For the purposes of the present disclosure, the term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, CD-RW, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

While online advertising has a number of advantages including the amount of information available, websites which consolidate information are frequently unable to track inventory from various advertisers unless they are acting as consolidators and have purchased the inventory themselves. The difficulty in knowing if inventory is available unless several additional steps are taken can lead to frustration on the p art of the end user, decreasing the effectiveness of such sites and increasing the costs to advertisers who are paying on a click through basis.

Various embodiments of the invention address this issue by providing a system configured to set up advertising campaigns that can additionally track and display the existing inventory of the vendor. Such systems can be used for any type of product or service. These systems may be particularly useful for tracking the inventory of specialty or limited edition items or items generally tied to a specific physical location such as reservation systems for entertainment venues, sporting events, restaurants, rentals, services, classes, personal care, transportation and accommodations.

In some embodiments, if there is no inventory available, the advertising system can let a consumer know when inventory is expected to be available. For example, if a hotel is booked on particular days, alternate availability may be shown. In another embodiment, if an item is on backorder, the expected time of delivery to the vendor may be displayed. In yet another embodiment, if an advertiser has comparable products, the comparable products may be shown. In a further embodiment, if the inventory is unavailable, the advertisement may not be shown.

In various embodiments, the present invention provides a system of establishing advertising campaigns that can track the specific inventory of particular vendors and relay that information to a customer along with an advertisement. Such systems may allow vendors to establish various parameters for the advertising campaigns and inventory determinations such as particular keywords, minimum stays, minimum or maximum purchases, blackout dates, promotions or any other parameters applicable to a particular advertising campaign. In some embodiments, the advertising system may include availability of the same inventory from third parties such as consolidators alone or in addition to information directly from vendors.

In some embodiments, the advertising website may connect customers to the vendor's inventory system. In other embodiments, the customer may be directed or redirected to a website for the product which has been selected. In another embodiment, the key words, search criteria or additional information entered into the advertising system by the consumer may be transferred to the selected vendors' inventory system or web page.

Vendors may have one or more types of inventory systems depending on the particular inventory. In one embodiment, each type of inventory system of a particular vendor can be connected separately to the advertising system. In other embodiments, each vendor may be connected once to the advertising system regardless of the number of inventory system types used.

The advertising systems herein may require more or less input from the vendor in order to establish an advertising campaign that displays available inventory. In some embodiments, the vendor may be required to input all of the initial data, for example, keyword selection, vendor type, inventory system type, vendor website address, or other relevant vendor information. In one embodiment, the advertising system may determine the vendor type based on the keyword selection and/or may suggest keywords based on the vendor type. In another embodiment, the advertising system may determine the inventory system type from the vendor website. In additional embodiments, varying combinations of input may be required or prompted by the advertising system.

For example, a hotel administrator may desire to set up an advertising campaign for a hotel at a p articular location. The hotel administrator may select a set of keywords relevant to booking a hotel room at that location. Keywords may include any of a variety of descriptors including the name of the hotel, the location of the hotel, the region in which the hotel is located, the amenities of the hotel, nearby sites of interest or any other relevant keyword. The hotel administrator may also indicate the type of venue, for example that it is a hotel and not a bed and breakfast, motel, lodge, resort, rental or other type of accommodation and provide the hotel website address. The hotel website address may be used as part of the promotion, the location to which the consumer is to be redirected and/or the source of the inventory data. In some embodiments, the advertising system may determine the type of venue based on the keyword selections. The advertising system may then determine what type, if any, of reservation engine the hotel is using and/or prompt the hotel administrator to indicate what type of reservation engine the hotel is using. The advertising system may then further determine whether or not the reservation engine is compatible with the advertising system. If the reservation engine is compatible with the advertising system, the system may scrape inventory data from the vendor website and output pricing information with the advertisement it displays on behalf of the hotel. Scraped data may include any inventory or other data that can be copied from a website and stored on another website. Inventory data may be scraped at any interval specified. In some embodiments, the inventory data may be checked one, two, three, four or more times per day, hour, minute, second or other unit of time. In one embodiment, the advertising system may determine how often the inventory is scraped. In another embodiment, the advertiser may select how often the inventory is scraped. In additional embodiments, the inventory may be scraped each time a keyword match is made. In further embodiments, the price of the advertisement may depend in part on how often the inventory is scraped. Similar systems may be used for any type of reservation or other type of inventory system. If the advertising system does not have an interface ability with that type of inventory system, the advertising system may request a link to the existing inventory system of the vendor supplied website. If an affirmative response is received from the vendor, the system automatically sets up an inventory database that is tied to advertising campaigns that it provides on behalf of the vendor. In some embodiments, an interface may be created by the advertising system personnel. In another embodiment, a genetic algorithm may construct an appropriate interface. In a further embodiment, if an advertiser does not have an automated inventory system, the advertising system can select a preferred inventory system to establish on behalf of the advertiser.

If no inventory is available, the data scrape may expand the routine to include comparable products or services or alternate times and dates. For example, if an advertiser manages vacation rentals and they have availability in a different rental unit than the one chosen, the rental units with availability may be displayed. Alternatively, if a consumer wants a blue product but the product is only available in red, the red product may be offered along with an estimate as to when the blue product will become available. In another embodiment, if the dates and times chosen by the consumer are unavailable, the search may be expanded to additional days or fewer days or alternate times on the same day. For example, if a consumer wants a two o'clock appointment on a particular day, the advertising system may display other days on which a two o'clock appointment is available and/or may display other times on the same day in which an appointment is available.

It will be appreciated that scraping media need not be limited to only HTML. Other suitable media include, but are not limited to, XML, javascript, CSS, Adobe Flash pages, images, audio, etc.

An exemplary system 100 configured to provide an advertising system as described above is shown in FIG. 2. As shown, system 100 may include an advertiser server 102, an advertisement server 110 and an inventory server 120. In some embodiments, all information may be stored on a single central server.

Advertiser server 102 may include advertisement set up program 104, advertiser database 106, keyword campaign database 108 and billing program 109, or any other databases and programs desired. Advertisement server 110 may include advertisement display program 112, redirect routine database 114, advertisement database 116, and advertisement display websites database 118 or any other databases and programs desired. Inventory server 120 may include inventory system determination program 122, inventory system database 124 and transaction database 126 or any other databases and programs desired.

Advertisement set up program 104 may allow the opening of vendor accounts, and/or the establishment of particular advertisement campaigns.

Advertiser database 106 may include information such as an advertiser ID, authorized users, website identifications, descriptors, vendor type, billing information, inventory system type, scrape routine identification, redirect routine identification, keyword campaigns, blackout date information, minimum stay requirements, minimum purchase requirements, maximum purchase restrictions, seasonal availability, special events, promotions, or any other relevant information applicable to an account.

Keyword campaign database 108 may include information relevant to each campaign an account is running, and/or information relevant to each vendor. Such a database may include information such a list of keywords including selected keywords, suggested keywords and rejected keywords, the advertiser identification, the identification of the generated advertisement, price per click for particular advertisements or particular keywords, or any other information relevant to a particular campaign(s).

Advertisement display program 112 may be used to create and present advertisements in response to searches by an end user and may be used alone or in conjunction with one or more databases with the advertisement system including those on the same or other servers.

Redirect routine database 114 may include information relevant for the completion of data on a vendor website, a redirect routine identification number, a redirect routine descriptor and a repair routine or any other data or programs necessary to connect a customer to a vendor website. In some embodiments, the redirect routine may transfer booking information or other search criteria from the advertising system website to the inventory system of the vendor.

Advertisement database 116 may include information such as advertisement identification, keyword identification, advertiser identification, descriptor, hyperlink, scrape routine identification and redirect routine identification or any other information relevant to tracking and utilizing an advertisement.

Advertisement display websites database 118 may include information such as website identification, descriptor, type, keywords, metatags, content, domain name, allowable advertisement identification, allowable advertiser identification or any additional data required to run a particular website.

Inventory system database 124 may include information such as inventory system identification, descriptor, type, scrape routine identification, redirect routine identification or any other additional information which is useful in tracking and verifying the inventory of a vendor. Such information may be received from or used in conjunction with inventory scraping program 128 which periodically scrapes inventory data from the vendor website.

Transaction database 126 may include information such as keyword(s), price per click, advertiser identification, advertisement identification, display website identification and the date/time a customer makes a purchase or any other information useful in identifying the specifics of a transaction.

A vendor may establish an advertising campaign in a variety of ways. In some embodiments, an advertiser may be required to apply for an account with the advertising system. In other embodiments, the account may be created automatically. Accounts may be created using, for example, advertisement set up program 104. Such accounts may support one or more websites with one or more inventory system types.

In some embodiments, account establishment may require billing information, verification of authority to establish a campaign, information about the vendor, the type of inventory system the vendor uses, descriptions of the inventory, the website of the vendor, or any other additional information needed to set up an account. In other embodiments, particular criteria may need to be met in order to create an account or to appear on a particular website. For example, in some embodiments, the keyword advertising website may be collecting advertisements for a particular venue, or with a particular theme, for example tourism. In order to open an account or appear on a particular website, the vendor must have a business which is applicable to that theme or venue. If the vendor does not have a business which matches that theme or venue, the vendor may be prevented from creating an account or from placing advertisements on a particular website.

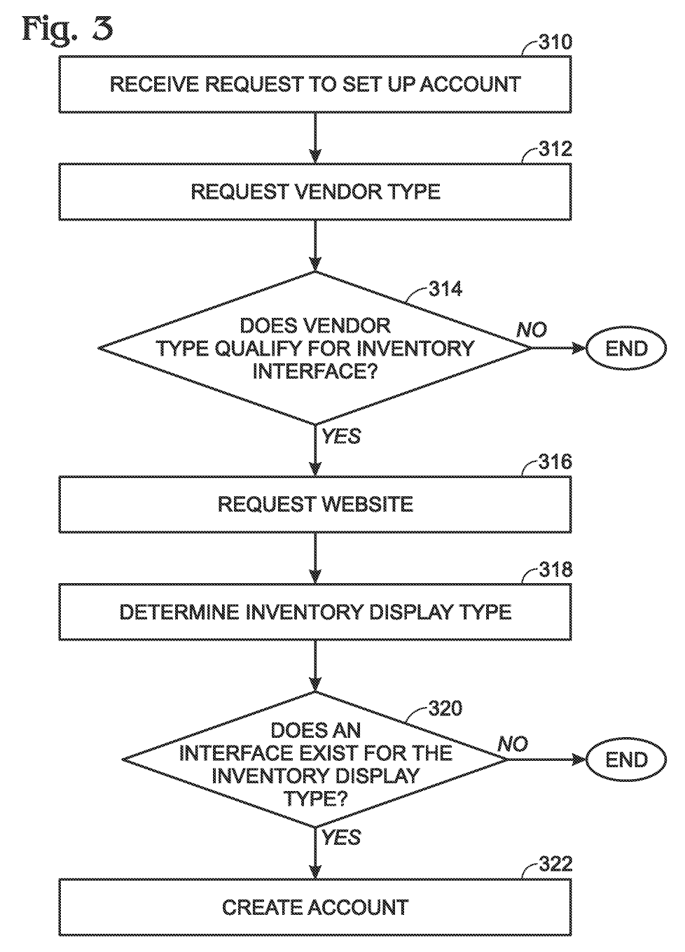

Such an account may be established using some or all of the steps in FIG. 3. In FIG. 3, the advertising system receives a request 310 to set up an advertising campaign. The system requests the vendor type in 312 and determines if the vendor type is the kind that generally has the type of inventory advertised by the advertising system in 314. If the type of inventory is not the type of inventory advertised by the advertising system, for example it does not fit the criteria set for a particular advertisement site such as it is in a particular location or sells a particular type of product, the request to create an account is denied. If the inventory type matches the criteria of the advertising system, the advertising system requests the web address in 316. The advertising system then scrapes the website to determine the inventory display type in 318 and then determines if an interface exists for the inventory display type in 320 that will allow the advertising system to periodically scrape the inventory available through the web address and allow the advertising system to display available inventory to a customer or other end user. If an interface does exist for the inventory display type an account for the vendor is created in 322.

Once an account is established or a determination is made that the vendor fits a particular profile, an advertisement campaign may be established. An advertisement campaign may be established by any means applicable. In one embodiment, advertisement set up program 104 may be configured to create an advertisement using some or all of the following steps:
1. Receive a request to establish an advertising campaign.
2. Determine type of campaign.
3. Receive inventory display website.
4. Determine type of vendor and at least one keyword.
5. Determine inventory type.
6. Output advertising campaign.

In another embodiment, vendors may merely be required to submit a request in order to establish an advertisement campaign. For example, a campaign may be created using one or more of the following steps:
1. Receive a request to set up a keyword campaign.
2. Determine if vendor type qualifies for an inventory interface.
3. If the inventory type qualifies, determine the inventory database type of the inventory display website.
4. Determine if an interface exists to the inventory display type.
5. Create and store an inventory interface to the inventory display website.

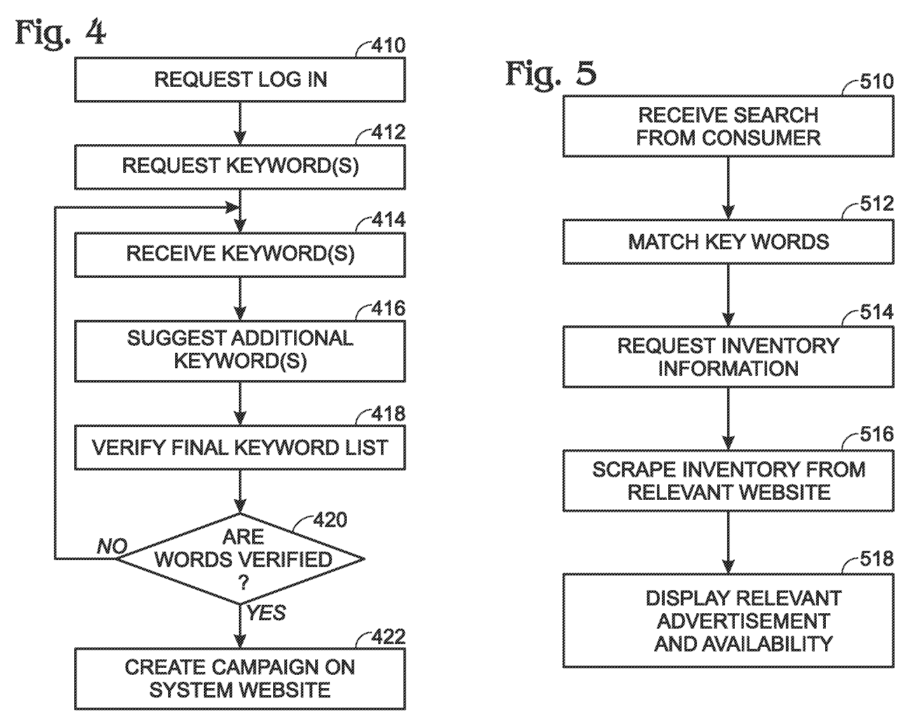

In some embodiments, vendors may input additional information such as a list of keywords or select keywords from a previously generated list or a combination thereof. For example, an advertising campaign may be created using one or all of the steps in FIG. 4. In FIG. 4, a vendor logs in at 410 and indicates that they wish to create an advertising campaign. The system requests keywords at 412 and receives the vendor's input at 414. Based on the keywords chosen by the vendor, the vendor's previously selected keywords, or the type of vendor, the advertising system may suggest additional keywords at 416. A final word list is generated and verified at 418 and approval for the keywords is granted at 420. If approval is not given, the system re-requests keywords at 414. Once approval has been received, the advertising system creates a campaign on the appropriate system website at 422. In some embodiments, the cost to run a particular advertisement campaign may be based on the keywords selected. For example, popular keywords may be more or less expensive depending on the marketing strategy of the advertising system. In some embodiments, charges to the vendor or a third party may be incurred each time a keyword is matched to a particular vendor. In other embodiments, charges to a vendor or third party may be incurred only if the vendor is selected or “clicked on” by a consumer. Fees for advertising campaigns may be paid by vendors, or by promoters or other third parties, for example, by chambers of commerce or tourism boards.

In some embodiments, access to the inventory may be controlled or limited by the vendor. For example, in some embodiments, vendors may run particular specials, or have restrictions such as minimum stay requirements, or minimum or maximum purchase requirements for particular types of inventory which are inputted into the inventory interface. Inventory requirements may additionally be required to meet particular thresholds before being displayed on an advertising website, for example, there may be a minimum availability requirement in order to display a p articular advertisement.

For example, in one embodiment for a hotel, there may be a minimum stay requirement in order to receive a particular price per night. In such an embodiment, some or all of the following steps may be used to input the minimum stay requirements into an inventory system database 124.
1. Receive request to set up a date range for a minimum stay.
2. Output minimum stay form.
3. Receive minimum stay requirements.
4. Store requirements.
   Similar routines may be run for minimum or maximum purchase requirements. The minimum stay or other purchase requirements may be applied by inventory scraping program 128 using some or all of the following steps:
1. Retrieve lodger listings with minimum stay requirements.
2. Apply minimum stay requirements to scrape routine.
3. Scrape inventory data from lodger.
4. Store availability.

Vendors may create one or more advertisements or one or more sets of advertisement campaigns directed to particular consumers or types of consumers. For example, campaigns may be targeted to highlight particular inventory, particular locations, distance from particular locations, price ranges, amenities, profiles of the consumer, previous searches run by the consumer, keyword choices or combinations as well as any other terms generally used in targeting advertising.

Once an advertising campaign has been established, it may be displayed on a particular website. In some embodiments, advertisements with inventory may appear in a special bucket or web page. In other embodiments, advertisements with inventory may pop up based on a search. In additional embodiments, particular types of advertisements may be grouped together. In some embodiments, advertisements with inventory may be interactive. In other embodiments, advertisements with inventory may be part of a widget.

In some embodiments, advertisements may be accessed by a consumer using some or all of the steps in FIG. 5. For example, the advertising system may receive a search from a consumer at 510, match the key words entered by the consumer 512 to stored advertisement campaigns, request inventory information 514 from the consumer such as particular dates, times, and quantities and scrape the inventory at 516 from the relevant websites and at 518 display the relevant advertisements and availability.

In some embodiments, an inventory scrape program may be run every time a search is initiated, or at regular intervals throughout the day, for example one, two, three, four or more times a second, a day, or a week. In other embodiments, if the specific availability that the consumer requests is not available, the display may include alternate options, for example, the number that is actually available, or additional days on which a particular rate is available.

The consumer can then select the advertiser which suits their needs and the inventory information or other search information previously entered in 514 can be carried forward to the vendor website, eliminating the necessity of repeatedly entering the same data or running a secondary search.

In some embodiments, the product, dates or times of service selected by the consumer may be unavailable. In such embodiments, the scrape program may expand the search criteria to provide alternate dates or time, alternate products, or comparable products and services. Such a routine may be applied using some or all of the following steps:
1. Run scrape routine.
2. Determine if scrape routine successfully scraped inventory.
3. If no, apply day number plus 1 rule to scrape routine up to n total days.
4. Was scrape successful?
5. If yes, store inventory information including minimum stay requirements.
   In some embodiments, such a routine may be run for a day number minus one, i.e. a shorter stay. A similar routine may be used for a product search using some or all of the following steps:
1. Run scrape routine.
2. Determine if scrape routine successfully scraped inventory.
3. If no, apply scrape to comparable products.
4. Was scrape successful?
5. If yes, store inventory information.
   For example, a search may be run for a particular product. The product itself may not be available, or that particular brand may not be available, but a similar product from the same or a different manufacturer is available. In that instance, the similar product may be offered as a substitute to the consumer. In some embodiments, the consumer or other end user may be able to prevent the system from offering substitutes if, for example, they are only interested in a specific product or specific dates and times of service.

It will be appreciated that the widgets and associated functionalities and systems may be incorporated into a system configured to provide surveys to users and provide results in response to those surveys. Exemplary systems and methods for such search and survey applications are described, for example, in U.S. patent application Ser. No. 11/608,150, entitled “Map and Inventory-Based On-Line Purchases,” filed Dec. 7, 2006, U.S. patent application Ser. No. 11/562,738, entitled “Survey Based Qualification of Keyword Searches,” filed Nov. 22, 2006, U.S. patent application Ser. No. 11/278,123, entitled “Survey Based Qualification of Keyword Searches,” filed Mar. 30, 2006, and also U.S. Provisional Patent Application Ser. No. 60/774,177, entitled “Survey Based Qualification of Keyword Searches,” filed Feb. 15, 2006, each of which is hereby incorporated by reference in its entirety.

### CONCLUSION

It will be appreciated that the configurations and routines disclosed herein are exemplary in nature, and that these specific embodiments are not to be considered in a limiting sense, because numerous variations are possible. The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

We claim:

1. A method comprising:
creating an advertisement on a website;
connecting the advertisement to an advertiser inventory system;
periodically scraping the inventory system; and
displaying available inventory in the advertisement.

2. The method of claim 1, wherein the inventory system is scraped in response to a search by a consumer.

3. The method of claim 1, wherein the inventory system is scraped at regular time intervals.

4. The method of claim 1, wherein the advertisement is displayed in response to a search by a consumer.

5. The method of claim 4, wherein the consumer may select an advertisement.

6. The method of claim 5, wherein selection of the advertisement by the consumer transfers the consumer to a website for the advertiser.

7. The method of claim 5, wherein selection of the advertisement by the consumer transfers the terms of the search to the website for the advertiser.

8. The method of claim 1, wherein more than one advertisement may be displayed on a website.

9. The method of claim 1, wherein the advertisement is for items with limited inventory.

10. The method of claim 1, wherein the advertisement is for lodging.

11. A method for creating an online advertising campaign comprising:
inputting a keyword and an inventory display website into an advertising system wherein the advertising system determines if an interface exists for the inventory display website and scrapes inventory data from the inventory display website to be displayed with the advertisement.

12. The method of claim 11, wherein the advertising system suggests additional keywords.

13. The method of claim 11, wherein the advertising system scrapes inventory data from the inventory display website in response to a consumer search.

14. The method of claim 11, wherein the advertising system scrapes inventory data from the inventory display website periodically.

15. The method of claim 11, wherein the advertiser additionally inputs the advertiser type.

16. The method of claim 11, wherein the advertising system determines a vendor type based on the inventory display website.

17. The method of claim 11, wherein the advertising system determines a vendor type based on the keyword inputted.

18. The method of claim 11, wherein if the inventory is unavailable, the advertisement is not displayed.

19. A system comprising:
a search engine configured to receive a search query for a product from a user and output a search result containing availability of the product by particular vendors to the user;
a user interface configured to allow a user to send a search query to the search engine;
a user interface that allows a user to select a particular vendor from the search result;
a redirect routine that transfers the search query to the selected vendor.

20. The system of claim 19, wherein if the product is unavailable, the search result indicates when the product will become available.
